(19) United States
(12) Patent Application Publication
(10) Pub. No.: US 2009/0303222 A1
(43) Pub. Date: Dec. 10, 2009

(54) PLASMA DISPLAY DEVICE AND METHOD FOR DRIVING PLASMA DISPLAY PANEL

(75) Inventors: Takahiko Origuchi, Osaka (JP); Hidehiko Shoji, Osaka (JP)

Correspondence Address: RATNERPRESTIA, P.O. BOX 980, VALLEY FORGE, PA, 19482, US

(73) Assignee: Matsushita Electric Industrial Co., Ltd., OSAKA (JP)

(21) Appl. No.: 12/279,357

(22) PCT Filed: Nov. 22, 2007
(86) PCT No.: PCT/JP2007/072648

§ 371 Date: Aug. 14, 2008

(30) Foreign Application Priority Data
Dec. 13, 2006 (JP) 2006-335400

(51) Int. Cl. G06F 3/038

(52) U.S. Cl. 345/213; 345/60

(57) ABSTRACT

Provided are a plasma display device and a method for driving the plasma display panel. The plasma display device with a panel having high luminance can generate a stable address discharge without increasing the voltage required to generate an address discharge when the current accumulated time of the panel has increased. To achieve this advantage, the plasma display device includes an accumulated-time-measurement-circuit and a scan-electrode-driving-circuit.

This Application is a U.S. National Phase Application of PCT International Application PCT/JP2007/072648.

### TECHNICAL FIELD

The present invention relates to a plasma display device used for wall-mounted TVs, large-size monitors, and the like, and also relates to a method for driving a plasma display panel.

### BACKGROUND ART

A plasma display panel (hereinafter, abbreviated as “panel”) is typified by the AC surface-discharge type panel including a large number of discharge cells between a front panel and a rear panel facing each other. The front panel includes a front glass substrate, display electrode pairs which are parallelly arranged on the substrate, and a dielectric layer and a protective layer which are formed in that order over the display electrode pairs. The display electrode pairs each consist of a scan electrode and a sustain electrode. The rear panel, on the other hand, includes a rear glass substrate, data electrodes which are parallelly arranged on the substrate, a dielectric layer which is formed over the data electrodes, and barrier ribs which are formed on the dielectric layer in parallel to the data electrodes. The surface of the dielectric layer and the side surfaces of the barrier ribs are covered with phosphor layers. The front panel and the rear panel face each other and are sealed in such a manner that the display electrode pairs and the data electrodes three-dimensionally intersect with each other. The front and rear panels have a discharge space therebetween filled with a discharge gas having a xenon partial pressure of, for example, 5%. The discharge cells are formed in the areas where the display electrode pairs and the data electrodes face each other In the panel with this structure, a gas discharge in each discharge cell generates ultraviolet light, which excites and illuminates red (R), green (G), and blue (B) phosphors to achieve color display.

The panel is generally driven by a sub-field method. In the sub-field method, one field period is divided into a plurality of sub-fields so as to select a combination of the sub-fields where the phosphors are to be illuminated, thereby achieving a gradation display.

Each sub-field includes an initializing period, an address period, and a sustain period. In the initializing period, an initializing discharge is generated and a wall charge is formed on each electrode necessary for a subsequent address operation. In addition, priming particles (a discharge initiator=excited particles) are generated to stabilize the generation of an address discharge. In the address period, an address pulse voltage is applied selectively only to the discharge cells that are to be used for display so as to generate an address discharge and hence to form a wall charge (hereinafter, these series of operations are also referred to as “an address operation”). In the sustain period, a sustain pulse voltage is applied alternately to the scan electrodes and the sustain electrodes of the display electrode pairs so that a sustain discharge is generated in the discharge cells that have generated an address discharge. As a result, the phosphor layers are illuminated in the discharge cells that have generated a sustain discharge so as to achieve image display.

As one of the sub-field methods, there has been a proposed method for driving a panel having an improved contrast ratio by minimizing the generation of illumination unrelated to gradation display. This is achieved by performing an initializing discharge using gradually changing voltage waveforms and by performing an initializing discharge selectively only in the discharge cells that have performed a sustain discharge.

This panel driving method is carried out, for example, as follows. In the initializing period of one of the plurality of sub-fields, an initializing operation is performed to generate an initializing discharge in all discharge cells (hereinafter abbreviated as “all-cell initializing operation”). In the initializing period of the remaining sub-fields, an initializing operation is performed to generate an initializing discharge only in the discharge cells that have performed a sustain discharge (hereinafter abbreviated as “selective initializing operation”). In such a driving, the illumination unrelated to image display is caused only by the discharge in the all-cell initializing operation. As a result, the luminance in the black display area (hereinafter, abbreviated as “black luminance”) is only due to the weak illumination in the all-cell initializing operation, thereby accomplishing a high contrast image display (see, for example, Patent Document 1 below).

Patent Document 1 further describes a so-called erasing discharge using a narrow pulse, which reduces the potential difference between the display electrode pairs due to the difference in wall charges therebetween by making the last sustain pulse in the sustain period have a shorter pulse width than the other sustain pulses. Stable generation of the erasing discharge using a narrow pulse stably secures the address operation in the address period of the subsequent sub-field, thereby achieving a plasma display device having a high contrast ratio.

In recent years, however, there is an expectation of further improvement in image display quality of plasma display devices along with their increasing definition and screen size. One of the approaches to improve image display quality is to increase the luminance. The luminance can be effectively increased by increasing the xenon partial pressure. This, however, requires a higher voltage for an address operation and makes the operation unstable. Moreover, the discharge characteristics of the panel change depending on the accumulated time during which the panel is supplied with current (hereinafter also referred to as “current accumulated time”). In short, the address pulse voltage necessary for the generation of a stable address discharge increases with increasing the current accumulated time. Therefore, in order to achieve a stable address operation, it is necessary to increase the address pulse voltage when the current accumulated time has increased.

Patent Document 1: Japanese Patent Unexamined Publication No. 2000-242224

### SUMMARY OF THE INVENTION

The plasma display device of the present invention includes a panel including a plurality of discharge cells having display electrode pairs each consisting of a scan electrode and a sustain electrode; an accumulated-time-measurement-circuit for measuring an accumulated time during which the panel is applied with current; and a scan-electrode-driving-circuit dividing one field period into a plurality of sub-fields each having an initializing period during which the scan electrodes are applied with a gradually decreasing ramp waveform voltage, an address period during which the scan electrodes are applied with a negative scan pulse voltage, and a sustain period, the scan-electrode-driving-circuit generating the ramp waveform voltage in the initializing period so as to initialize the discharge cells, and generating the scan pulse voltage in the address period so as to drive the scan electrodes, wherein the scan-electrode-driving-circuit changes the minimum voltage of the gradually decreasing ramp waveform voltage depending on the accumulated time measured by the accumulated-time-measurement-circuit.

In the structure, the minimum voltage of a decreasing ramp waveform voltage to be generated in the initializing period is changed depending on the accumulated time during which the panel is supplied with current. This makes it possible for a panel having high luminance to generate a stable address discharge without increasing the address pulse voltage when the current accumulated time of the panel has increased.

### BRIEF DESCRIPTION OF THE DRAWINGS

FIG. 1 is an exploded perspective view of a panel according to a first embodiment of the present invention.

FIG. 2 is an electrode array of the panel.

FIG. 3 shows driving voltage waveforms to be applied to the electrodes of the panel.

FIG. 4 shows a sub-field structure of a plasma display device according to the first embodiment of the present invention.

FIG. 5A shows a driving voltage waveform to be applied to a scan electrode according to the first embodiment of the present invention when the current accumulated time of the panel measured by the accumulated-time-measurement-circuit is equal to or less than a predetermined time.

FIG. 5B shows a driving voltage waveform to be applied to the scan electrode according to the first embodiment of the present invention after the current accumulated time of the panel measured by the accumulated-time-measurement-circuit exceeds the predetermined time.

FIG. 6 shows the relation between the current accumulated time of the panel and address pulse voltage Vd necessary for the generation of a stable address discharge in the first embodiment of the present invention.

FIG. 7 shows the relation between initialization voltage Vi4 and address pulse voltage Vd necessary for the generation of the stable address discharge in the first embodiment of the present invention.

FIG. 8 is a circuit block diagram of a plasma display device according to the first embodiment of the present invention.

FIG. 9 is a circuit diagram of a scan-electrode-driving-circuit in the first embodiment of the present invention.

FIG. 10 is a timing chart showing an example of the operation of the scan-electrode-driving-circuit in an all-cell initializing period in the first embodiment of the present invention.

FIG. 11 is a timing chart showing another example of the operation of the scan-electrode-driving-circuit in the all-cell initializing period in the first embodiment of the present invention.

FIG. 12A shows an example of a sub-field structure in a second embodiment of the present invention.

FIG. 12B shows another example of the sub-field structure in the second embodiment of the present invention.

FIG. 13A shows an example of a sub-field structure in the second embodiment of the present invention in which initialization voltage Vi4 has three voltage levels.

FIG. 13B shows another example of the sub-field structure in the second embodiment of the present invention in which initialization voltage Vi4 has three voltage levels.

### REFERENCE MARKS IN THE DRAWINGS

1 plasma display device

10 panel

21 (glass) front substrate

22 scan electrode

23 sustain electrode

24 display electrode pair

25, 33 dielectric layer

26 protective layer

31 rear substrate

32 data electrode

34 barrier rib

35 phosphor layer

41 image-signal-processing-circuit

42 data-electrode-driving-circuit

43 scan-electrode-driving-circuit

44 sustain-electrode-driving-circuit

45 timing-generating-circuit

48 accumulated-time-measurement-circuit

50 sustain-pulse-generating-circuit

51 power-recovery-circuit

52 clamp circuit

53 initialization-waveform-generating-circuit

54 scan-pulse-generating-circuit

81 timer

Q1, Q2, Q3, Q4, Q11, Q12, Q13, Q14, Q21, QH1 to QHn, QL1 to QLn switching element

C1, C10, C11, C12, C21 capacitor

R10, R11 resistor

INa, INb input terminal

D1, D2, D10, D21 diode

L1 inductor

IC1 to ICn control circuit

CP comparator

AG AND gate

### DETAILED DESCRIPTION OF PREFERRED EMBODIMENTS

A plasma display device according to embodiments of the present invention is described as follows with reference to drawings.

### First Embodiment

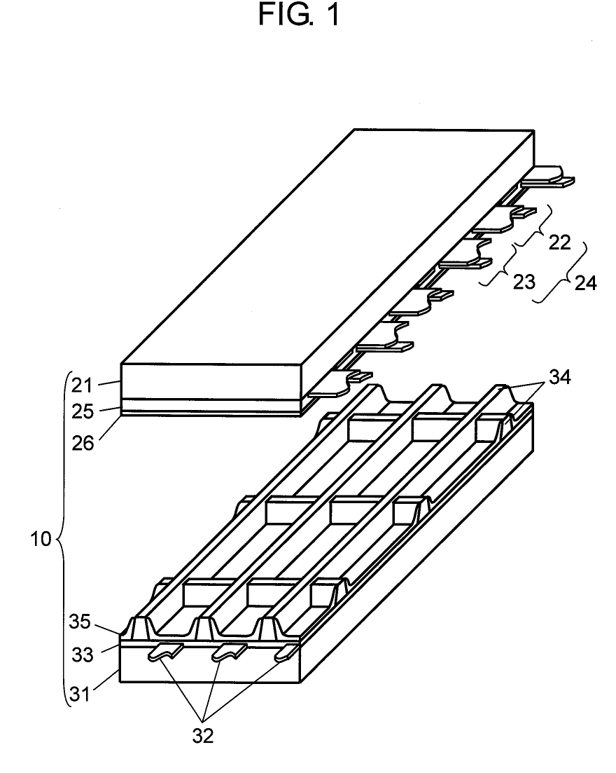

FIG. 1 is an exploded perspective view of panel 10 according to a first embodiment of the present invention. Panel 10 includes front substrate 21 made of glass. Front substrate 21 is provided thereon with a plurality of display electrode pairs 24 each consisting of scan electrode 22 and sustain electrode 23, and further with dielectric layer 25 and protective layer 26 arranged in this order to cover scan electrodes 22 and sustain electrodes 23.

In order to decrease the starting voltage in discharge cells, protective layer 26 is made of a material based on MgO, which is field proven as material for the panels and has a large secondary electron emission coefficient and excellent durability when the discharge space is filled with the mixed gas of neon (Ne) and xenon (Xe).

Panel 10 further includes rear substrate 31. Rear substrate 31 is provided thereon with data electrodes 32, dielectric layer 33 covering data electrodes 32, and barrier ribs 34 arranged further thereon in a parallel cross pattern. The side surfaces of barrier ribs 34 and the surface of dielectric layer 33 are covered with phosphor layers 35 of red (R), green (G), and blue (B).

Front substrate 21 and rear substrate 31 face each other in such a manner that display electrode pairs 24 and data electrodes 32 intersect with each other with a small discharge space interposed therebetween. Front substrate 21 and rear substrate 31 are sealed by a sealing member such as a glass frit at their periphery. The discharge space is filled with, for example, a mixed gas of neon and xenon as a discharge gas. In the present embodiment, the discharge gas has a xenon partial pressure of about 10% in order to have a high luminance. The discharge space is partitioned into a plurality of sections by barrier rib 34 so as to form discharge cells at the intersections of display electrode pairs 24 and data electrodes 32. These discharge cells perform a discharge to generate illumination, thereby achieving image display.

The structure of panel 10 is not limited to that described above. For example, the barrier ribs may be formed in a stripe pattern. The proportions of the components in the discharge gas are not limited to that described above, either.

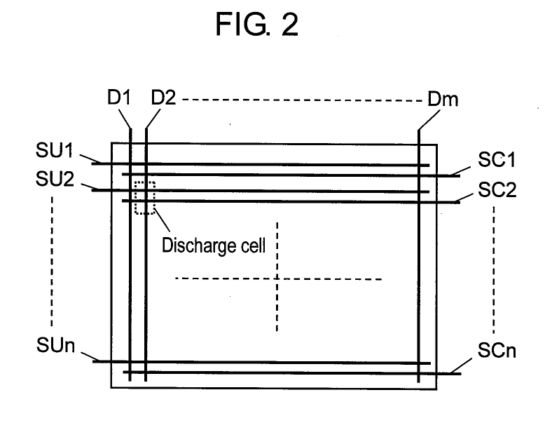

FIG. 2 is an electrode array of panel 10 according to the first embodiment of the present invention. Panel 10 includes n scan electrodes SC1 to SCn (scan electrodes 22 of FIG. 1) and n sustain electrodes SU1 to SUn (sustain electrodes 23 of FIG. 1) extending in the row direction, and m data electrodes D1 to Dm (data electrodes 32 of FIG. 1) extending in the column direction. The discharge space includes m×n discharge cells each formed at the intersection of one pair of scan electrode SCi (i=1 to n) and sustain electrode SUi and one data electrode Dj (j=1 to m).

The following is a description of driving voltage waveforms to drive PDP 10 and their operations. The plasma display device according to the present embodiment performs gradation display by a sub-field method. In the sub-field method, one field period is divided into a plurality of sub-fields and the on-off of illumination in each discharge cell is controlled sub-field by sub-field. Each sub-field includes an initializing period, an address period, and a sustain period.

In the initializing period of each sub-field, an initializing discharge is generated so that a wall charge necessary for a subsequent address discharge is formed on each electrode. The initializing period also has the function of generating priming particles (the discharge initiator=excited particles) in order to reduce the discharge delay, thereby stabilizing the generation of an address discharge. The initializing operation is classified into an all-cell initializing operation to generate an initializing discharge in all discharge cells and a selective initializing operation to generate an initializing discharge only in the discharge cells that have performed a sustain discharge in the immediately preceding sub-field.

In the address period, an address discharge is generated to form wall charges selectively only in the discharge cells in which to generate illumination in the subsequent sustain period. In the sustain period, sustain pulses whose number is in proportion to the luminance weight are applied alternately to scan electrodes 22 and sustain electrodes 23 of display electrode pairs 24. Consequently, a sustain discharge is generated in the discharge cells that have generated an address discharge so as to generate illumination in the discharge cells. The constant of proportionality in this case is called “luminance ratio”.

In the present embodiment, one field is divided into ten sub-fields (1st SF, 2nd SF, . . . , 10th SF), and these sub-fields have luminance weights of, for example, (1, 2, 3, 6, 11, 18, 30, 44, 60, and 80), respectively. In the initializing period of the 1st SF, the all-cell initializing operation is performed, whereas in the initializing period of each of the 2nd to the 10th SF, the selective initializing operation is performed. In the sustain period of each sub-field, display electrode pairs 24 are applied with sustain pulses whose number is determined by multiplying the luminance weight of each sub-field by a predetermined luminance ratio.

The present embodiment, however, is not limited to the aforementioned number of the sub-fields or the luminance weight of each sub-field, and may switch sub-field structures based on the image signal or the like.

In the present embodiment, the minimum voltage of the gradually decreasing ramp waveform voltage to be applied to scan electrodes SC1 to SCn in the initializing period is controlled according to the accumulated time during which panel 10 is applied with current. The accumulated time is measured by an accumulated-time-measurement-circuit which is described later. More specifically, after the current accumulated time of panel 10 exceeds a predetermined time, the minimum voltage of the gradually decreasing ramp waveform voltage is set to the lowest voltage level in the initializing period of every sub-field. As a result, a stable address discharge can be generated without increasing the voltage required to generate an address discharge. The following is the outline of the driving voltage waveforms and their differences between when the current accumulated time measured by the accumulated-time-measurement-circuit is equal to or less than a predetermined time and after the current accumulated time exceeds the predetermined time.

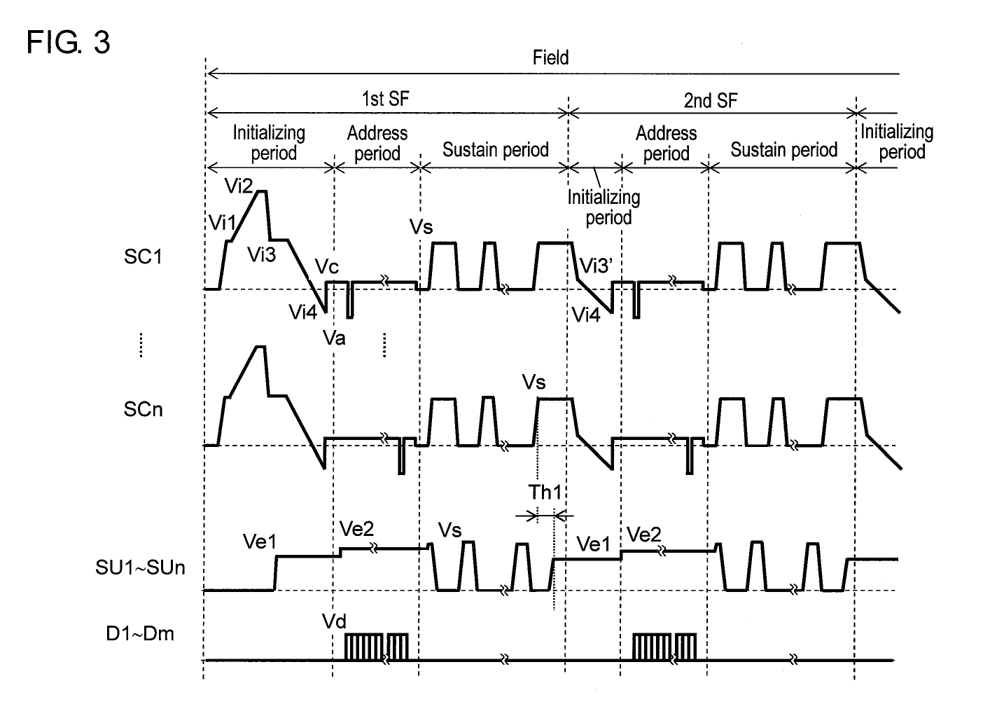

FIG. 3 shows driving voltage waveforms to be applied to the electrodes of panel 10 of the first embodiment of the present invention. FIG. 3 includes the driving voltage waveforms in two sub-fields. One is a sub-field in which to perform an all-cell initializing operation (hereinafter, referred to as “all-cell initializing sub-field”), and the other is a sub-field in which to perform a selective initializing operation (hereinafter, referred to as “selective initializing sub-field”). The remaining sub-fields have driving voltage waveforms nearly the same as these.

The following is a description of the 1st SF, which is an all-cell initializing sub-field. In the first half of the initializing period of the 1st SF, data electrodes D1 to Dm and sustain electrodes SU1 to SUn are applied with 0V. Scan electrodes SC1 to SCn are applied with a ramp waveform voltage gradually increasing (hereinafter, referred to as “up ramp waveform voltage”) from voltage Vi1 to voltage Vi2, which exceeds the starting voltage. At voltage Vi1, the voltage difference between scan electrodes SC1 to SCn and sustain electrodes SU1 to SUn is equal to or less than the starting voltage.

During the increase in the up ramp waveform voltage, a weak initializing discharge continues between scan electrodes SC1 to SCn and sustain electrodes SU1 to SUn and between scan electrodes SC1 to SCn and data electrodes D1 to Dm. Consequently, a negative wall voltage is accumulated on scan electrodes SC1 to SCn, whereas a positive wall voltage is accumulated on data electrodes D1 to Dm and on sustain electrodes SU1 to SUn. The wall voltage on electrodes indicates the voltage generated by wall charges accumulated on the dielectric layers, protective layer, and phosphor layers covering these electrodes.

In the second half of the initializing period, sustain electrodes SU1 to SUn are applied with positive voltage Ve1. Data electrodes D1 to Dm are applied with 0V. Scan electrodes SC1 to SCn are applied with a ramp waveform voltage gradually decreasing (hereinafter, referred to as “down ramp waveform voltage”) from voltage Vi3 to voltage Vi4, which exceeds the starting voltage. At voltage Vi3, the voltage difference between scan electrodes SC1 to SCn and sustain electrodes SU1 to SUn is equal to or less than the starting voltage. Hereinafter, the minimum voltage of the down ramp waveform voltage to be applied to scan electrodes SC1 to SCn is referred to as “initialization voltage Vi4”. During the decrease in the down ramp waveform voltage, a weak initializing discharge continues between scan electrodes SC1 to SCn and sustain electrodes SU1 to SUn and between scan electrodes SC1 to SCn and data electrodes D1 to Dm. This reduces the negative wall voltage on scan electrodes SC1 to SCn and the positive wall voltage on sustain electrodes SU1 to SUn. The positive wall voltage on data electrodes D1 to Dm is adjusted to a value suitable for an address operation. As a result, the all-cell initializing operation to generate an initializing discharge in all discharge cells is complete.

In the present embodiment, panel 10 is driven by switching initialization voltage Vi4 between two voltage levels. Although not illustrated in FIG. 3, the high voltage level is referred to as Vi4H, and the low voltage level is referred to as Vi4L.

After the current accumulated time of panel 10 measured by the after-mentioned accumulated-time-measurement-circuit exceeds the predetermined time, initialization is performed using a down ramp waveform voltage having initialization voltage Vi4 set to Vi4L in the initializing period of every sub-field. This configuration is described in detail later. This makes it possible to generate a stable address discharge without increasing address pulse voltage Vd when the current accumulated time has increased.

In the subsequent address period, sustain electrodes SU1 to SUn are applied with voltage Ve2, and scan electrodes SC1 to SCn are applied with voltage Vc.

First, negative scan pulse voltage Va is applied to scan electrode SC1 in the first row. At the same time as this, positive address pulse voltage Vd is applied to data electrode Dk (k=1 to m) of the discharge cells in which to generate illumination in the first row, of data electrodes D1 to Dm. At this moment, the voltage difference at the intersection of data electrode Dk and scan electrode SC1 exceeds the starting voltage. This is because the voltage difference is equal to the sum of the difference between the voltages (Vd−Va) applied from the outside and the difference between the wall voltage on data electrode Dk and the wall voltage on scan electrode SC1. This generates an address discharge between data electrode Dk and scan electrode SC1 and between sustain electrode SUI and scan electrode SC1, thereby accumulating a positive wall voltage on scan electrode SC1 and a negative wall voltage on sustain electrode SU1 and on data electrode Dk.

In this manner, an address discharge is generated in the discharge cells in which to generate illumination in the first row, thereby performing an address operation to accumulate a wall voltage on each electrode. On the other hand, the voltage difference at the intersections of those of data electrodes D1 to Dm that have not been applied with address pulse voltage Vd and scan electrode SC1 does not exceed the starting voltage. Therefore, no address discharge is generated in the corresponding discharge cells. The address operation is performed to reach the discharge cells in the n-th row so as to complete the address period.

In the subsequent sustain period, scan electrodes SC1 to SCn are applied with positive sustain pulse voltage Vs, and sustain electrodes SU1 to SUn are applied with 0V. As a result, in the discharge cells that have generated an address discharge, the difference between the voltage on scan electrode SCi and the voltage on sustain electrode SUi exceeds the starting voltage. This is because the voltage difference is equal to the sum of sustain pulse voltage Vs and the difference between the wall voltage on scan electrode SCi and the wall voltage on sustain electrode SUi.

This generates a sustain discharge between scan electrode SCi and sustain electrode SUi, and the ultraviolet light generated at this moment illuminates phosphor layers 35. As a result, a negative wall voltage is accumulated on scan electrode SCi and a positive wall voltage is accumulated on sustain electrode SUi and on data electrode Dk. The discharge cells that have not generated an address discharge in the address period do not generate a sustain discharge and maintain the wall voltage at the level of the end of the initializing period.

Next, scan electrodes SC1 to SCn are applied with 0V, and sustain electrodes SU1 to SUn are applied with sustain pulse voltage Vs. As a result, in the discharge cells that have generated a sustain discharge, the difference between the voltage on sustain electrode SUi and the voltage on scan electrode SCi exceeds the starting voltage. This generates another sustain discharge between sustain electrode SUi and scan electrode SCi, thereby accumulating a negative wall voltage on sustain electrode SUi and a positive wall voltage on scan electrode SCi. In the same manner, sustain pulses whose number is determined by multiplying the luminance weight by the luminance ratio are applied alternately to scan electrodes SC1 to SCn and sustain electrodes SU1 to SUn so as to provide a potential difference between the electrodes of display electrode pairs 24. As a result, a sustain discharge is continued in the discharge cells that have generated an address discharge in the address period.

At the end of the sustain period, a voltage difference is applied in the form of a small-width pulse between scan electrodes SC1 to SCn and sustain electrodes SU1 to SUn so as to erase the wall voltage on scan electrode SCi and on sustain electrode SUi with the positive wall voltage left on data electrode Dk. Hereinafter, this discharge is referred to as “erase discharge”.

When a predetermined time period has passed after scan electrodes SC1 to SCn are applied with voltage Vs to generate the final sustain discharge, that is, the erase discharge, sustain electrodes SU1 to SUn are applied with voltage Ve1 to reduce the potential difference between the electrodes of display electrode pairs 24. As a result, the sustain operation in the sustain period is complete.

The following is a description of the operation in the 2nd SF, which is a selective initializing sub-field.

In the selective initializing period of the 2nd SF, scan electrodes SC1 to SCn are applied with a down ramp waveform voltage gradually decreasing from voltage Vi3′ to initialization voltage Vi4, while sustain electrodes SU1 to SUn are maintained at voltage Ve1 and data electrodes D1 to Dm are maintained at 0V.

This generates a weak initializing discharge in the discharge cells that have generated a sustain discharge in the sustain period of the preceding sub-field, thereby reducing the wall voltage on scan electrode SCi and on sustain electrode SUi. There is a sufficient amount of positive wall voltage accumulated on data electrode Dk as a result of the immediately preceding sustain discharge, and the excess of the wall voltage is discharged so as to make the wall voltage suitable for an address operation.

On the other hand, the discharge cells that have not generated a sustain discharge in the preceding sub-field do not generate a discharge and maintain the wall charge at the level of the end of the initializing period of the preceding sub-field. Thus, in the selective initializing operation, an initializing discharge is selectively performed only in the discharge cells that have performed a sustain operation in the sustain period of the immediately preceding sub-field.

In the present embodiment, in the selective initializing operation, initialization voltage Vi4 is switched between high voltage level Vi4H and low voltage level Vi4L in the same manner as the down ramp waveform voltage in the all-cell initializing operation.

The operation in the subsequent address period is not described because it is the same as in the address period of the all-cell initializing sub-field. The operation in the subsequent sustain period is also the same except for the number of the sustain pulses. The operation in the initializing period of each of the 3rd to the 10th SF is the same selective initializing operation as in the 2nd SF. The address operation in the address period is also the same as in the 2nd SF, and the operation in the sustain period is also the same except for the number of the sustain pulses.

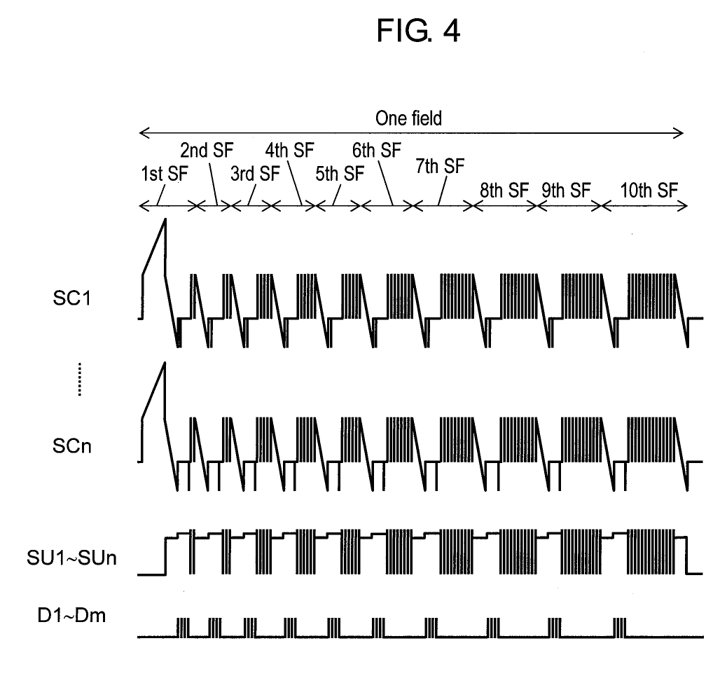

FIG. 4 shows a sub-field structure of a plasma display device according to the first embodiment of the present invention. In the sub-field structure, the driving waveforms within one field are shown in a simplified manner, but identical in each sub-field to the driving voltage waveforms of FIG. 3.

As described above, FIG. 4 shows the sub-field structure of the present embodiment where one field is divided into ten sub-fields (1st SF, 2nd SF, . . . , 10th SF), and these sub-fields have luminance weights of (1, 2, 3, 6, 11, 18, 30, 44, 60, and 80), respectively. The 1st SF is an all-cell initializing sub-field, and the 2nd to the 10th SF are selective initializing sub-fields. In the sustain period of every sub-field, display electrode pairs 24 are applied with sustain pulses whose number is determined by multiplying the luminance weight of each sub-field by a predetermined luminance ratio.

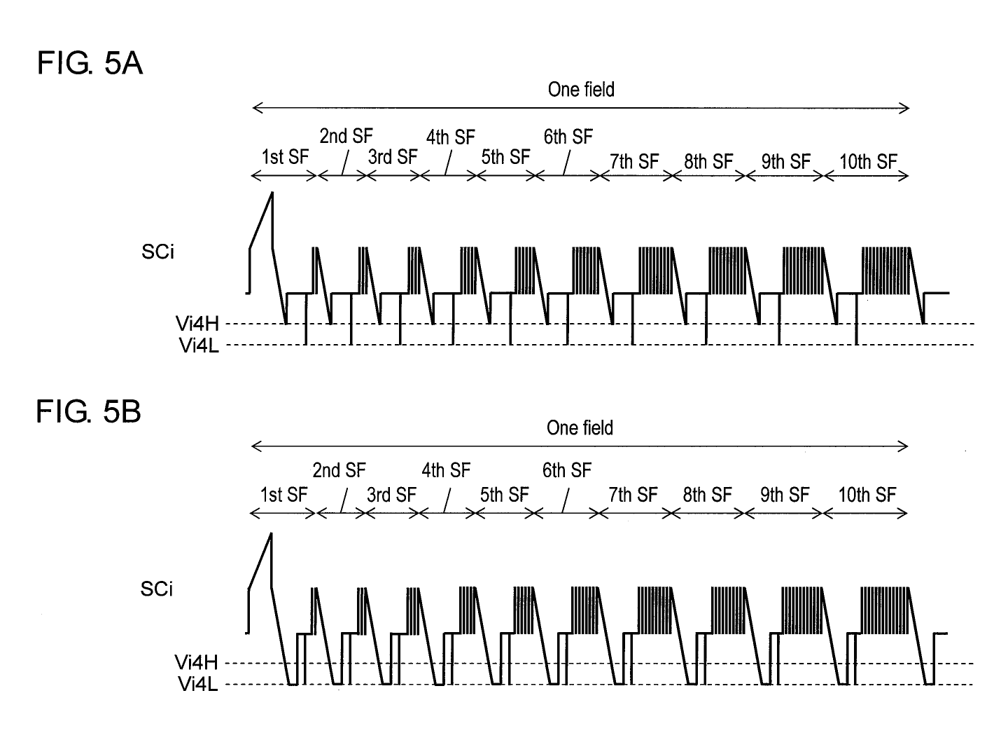

The down ramp waveform voltage of the driving voltage waveform to be applied to scan electrodes SC1 to SCn is changed depending on the current accumulated time of panel 10. The detail is described as follows with reference to FIG. 5A, 5B.

FIG. 5A, 5B shows driving voltage waveforms to be applied to scan electrodes SC1 to SCn according to the first embodiment of the present invention. FIG. 5A shows a waveform when the current accumulated time of panel 10 measured by the accumulated-time-measurement-circuit is equal to or less than a predetermined time (500 hours or less in the present embodiment). FIG. 5B shows a waveform after the current accumulated time exceeds the predetermined time (over 500 hours in the present embodiment).

As described above, in the present embodiment, the down ramp waveform voltage is generated by switching initialization voltage Vi4, which is the minimum voltage of the down ramp waveform voltage, between two voltage levels: high voltage level Vi4H and low voltage level Vi4L. The voltage level of initialization voltage Vi4 is switched between Vi4L and Vi4H depending on whether the current accumulated time of panel 10 measured by the after-mentioned accumulated-time-measurement-circuit has exceeded the predetermined time or not.

More specifically, when the accumulated-time-measurement-circuit determines that the current accumulated time of panel 10 is equal to or less than 500 hours, as shown in FIG. 5A, an initialization is performed by generating a down ramp waveform voltage having initialization voltage Vi4 set to Vi4H in the initializing period of every sub-field.

On the other hand, when the accumulated-time-measurement-circuit determines that the current accumulated time of panel 10 has exceeded 500 hours, as shown in FIG. 5B, an initialization is performed by generating a down ramp waveform voltage having initialization voltage Vi4 set to Vi4L in the initializing period of every sub-field. This structure can achieve a stable address discharge in the present embodiment due to the following features.

The discharge characteristics change depending on the current accumulated time of panel 10. In addition, factors to make the discharge unstable such as a discharge delay and a dark current also change depending on the current accumulated time of panel 10. The discharge delay indicates the time after a voltage to generate a discharge is applied to discharge cells and until the generation of a discharge. The dark current indicates a current generated in a discharge cell independently of discharge. As a result, the applied voltage required to generate a stable address discharge also changes depending on the current accumulated time of panel 10.

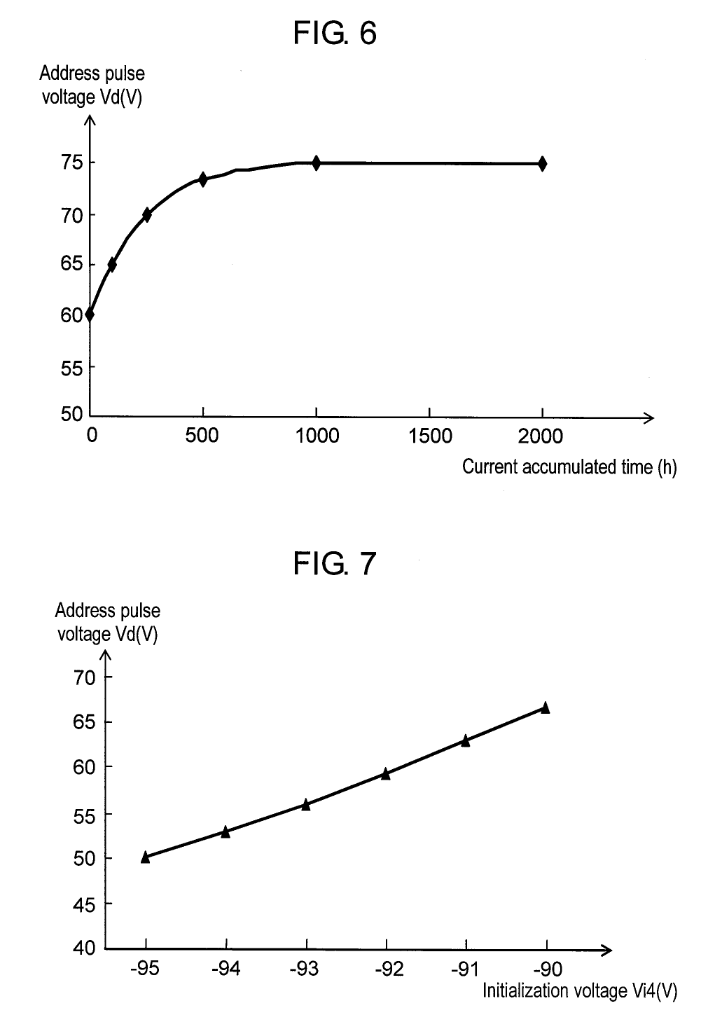

FIG. 6 shows the relation between the current accumulated time of the panel and address pulse voltage Vd necessary for the generation of a stable address discharge in the first embodiment of the present invention. In FIG. 6, the vertical axis represents address pulse voltage Vd required to generate a stable address discharge, and the horizontal axis represents the current accumulated time of panel 10.

As shown in FIG. 6, as the current accumulated time of panel 10 increases, a higher address pulse voltage Vd is required to generate a stable address discharge. For example, when the current accumulated time is 0 hours in the initial state, address pulse voltage Vd required is about 60V. When the current accumulated time is about 500 hours, address pulse voltage Vd required is about 73V, which is higher by about 13V. After the current accumulated time has reached about 1000 hours, address pulse voltage Vd required stays around 75V.

On the other hand, in the initializing operation to form a wall charge necessary for an address discharge on each electrode, an initializing discharge is generated by applying a down ramp waveform voltage to scan electrodes SC1 to SCn. As a result, the state of the wall charge formed on each electrode changes depending on the voltage level of initialization voltage Vi4 which is the minimum voltage of the down ramp waveform voltage. In addition, the applied voltage necessary for the subsequent address discharge changes in the same manner The initialization voltage Vi4 and the applied voltage have the following relation.

FIG. 7 shows the relation between initialization voltage Vi4 and address pulse voltage Vd necessary for the generation of the stable address discharge in the first embodiment of the present invention. In FIG. 7, the vertical axis represents address pulse voltage Vd required to generate a stable address discharge, and the horizontal axis represents initialization voltage Vi4.

As shown in FIG. 7, address pulse voltage Vd required to generate a stable address discharge changes depending on the level of initialization voltage Vi4. As initialization voltage Vi4 decreases, address pulse voltage Vd required to generate a stable address discharge also decreases. For example, when initialization voltage Vi4 is about −90V, address pulse voltage Vd is about 66V. When initialization voltage Vi4 is about −95V, address pulse voltage Vd is about 50V. Thus, when initialization voltage Vi4 is decreased from about −90V to about −95V, address pulse voltage Vd required to generate a stable address discharge decreases by about 16V.

Thus, it has been confirmed that address pulse voltage Vd required to generate a stable address discharge increases as the current accumulated time increases, and decreases as initialization voltage Vi4 decreases. More specifically, an increase in the current accumulated time causes an increase in address pulse voltage Vd required to generate a stable address discharge, but the increase in address pulse voltage Vd can be compensated by decreasing initialization voltage Vi4 depending on the current accumulated time. As a result, a stable address discharge can be generated without increasing address pulse voltage Vd.

In the present embodiment, the after-mentioned accumulated-time-measurement-circuit measures the current accumulated time of panel 10. When the current accumulated time is equal to or less than a predetermined time (500 hours or less in the present embodiment), the down ramp waveform voltage is generated with initialization voltage Vi4 set to Vi4H as shown in FIG. 5A. After the current accumulated time exceeds the predetermined time (over 500 hours in the present embodiment), the down ramp waveform voltage is generated with initialization voltage Vi4 set to Vi4L, which is lower than Vi4H as shown in FIG. 5B. This achieves a stable address operation without increasing address pulse voltage Vd required to generate a stable address discharge.

Although not illustrated, it has been confirmed that a decrease in initialization voltage Vi4 causes an increase in the amplitude of a scan pulse voltage required to generate a stable address discharge in opposite to the case of address pulse voltage Vd. Therefore, in the present embodiment, while taking the amplitude of the required scan pulse voltage into consideration, Vi4L is set to −95V, and Vi4H is set to −90V, which is higher by 5V than Vi4L.

This experiment is applied to a 50 inch panel having 1080 display electrode pairs. The aforementioned values are based on this panel, so that the present embodiment is not limited to these values.

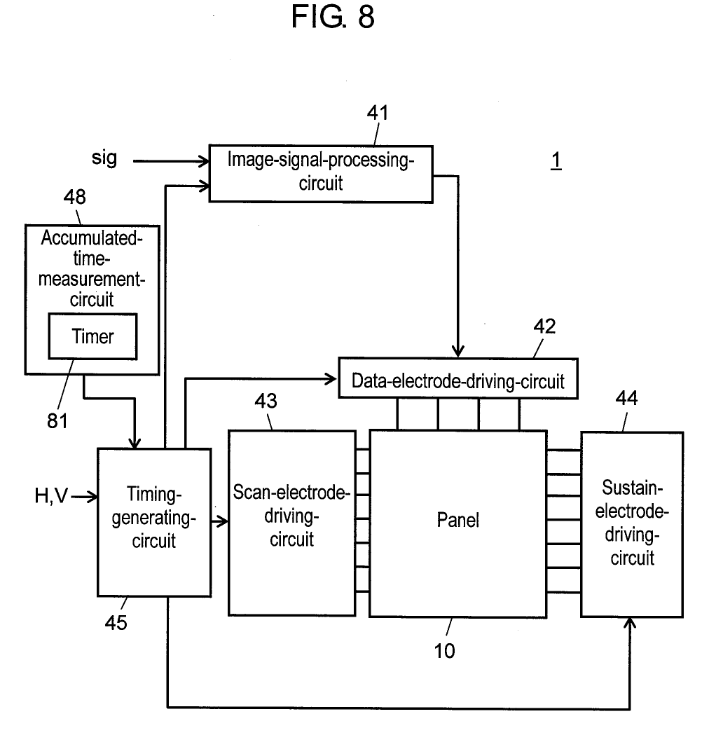

The plasma display device according to the present embodiment is described as follows. FIG. 8 is a circuit block diagram of the plasma display device according to the first embodiment of the present invention. Plasma display device 1 includes panel 10, image-signal-processing-circuit 41, data-electrode-driving-circuit 42, scan-electrode-driving-circuit 43, sustain-electrode-driving-circuit 44, timing-generating-circuit 45, accumulated-time-measurement-circuit 48, and a power supply circuit (unillustrated), which supplies each circuit block with necessary power.

Image-signal-processing-circuit 41 converts a received image signal “sig” into image data indicating the on-off of illumination in each sub-field. Data-electrode-driving-circuit 42 converts the image data in each sub-field into signals corresponding to data electrodes D1 to Dm so as to drive data electrodes D1 to Dm.

Accumulated-time-measurement-circuit 48 includes well-known timer 81 for increasing the value by a constant amount at regular time intervals while panel 10 is applied with current. In timer 81, the elapsed time is accumulated so as to measure the accumulated time during which panel 10 is applied with current. Then, accumulated-time-measurement-circuit 48 compares the current accumulated time of panel 10 measured by timer 81 with a predetermined threshold value so as to determine whether the current accumulated time of panel 10 has exceeded the predetermined time or not. Accumulated-time-measurement-circuit 48 then outputs a signal indicating the determined result to timing-generating-circuit 45.

In the present embodiment, the threshold value is set to 500 hours, but is not limited to this value. It is preferably set to a value determined according to the characteristics of the panel, the specification of the plasma display device, or the like.

Timing-generating-circuit 45 generates various timing signals to control the operations of these circuit blocks, and outputs them to the circuit blocks. Timing-generating-circuit 45 generates the timing signals based on a horizontal synchronizing signal H, a vertical synchronizing signal V, and the current accumulated time of panel 10 measured by accumulated-time-measurement-circuit 48. As described above, in the present embodiment, initialization voltage Vi4 of the down ramp waveform voltage to be applied to scan electrodes SC1 to SCn in the initializing period is controlled based on the current accumulated time. Timing-generating-circuit 45 outputs a timing signal corresponding to the current accumulated time to scan-electrode-driving-circuit 43. As a result, the stabilization of a address operation is controlled.

Scan-electrode-driving-circuit 43 includes an initialization-waveform-generating-circuit, a sustain-pulse-generating-circuit, and a scan-pulse-generating-circuit. The initialization-waveform-generating-circuit generates an initializing waveform voltage to be applied to scan electrodes SC1 to SCn in the initializing period. The sustain-pulse-generating-circuit generates a sustain pulse voltage to be applied to scan electrodes SC1 to SCn in the sustain period. The scan-pulse-generating-circuit generates a scan pulse voltage to be applied to scan electrodes SC1 to SCn in the address period. Scan-electrode-driving-circuit 43 drives scan electrodes SC1 to SCn based on the timing signal. Sustain-electrode-driving-circuit 44 includes a sustain-pulse-generating-circuit and a circuit for generating voltages Ve1 and Ve2, and drives sustain electrodes SU1 to SUn based on the timing signal.

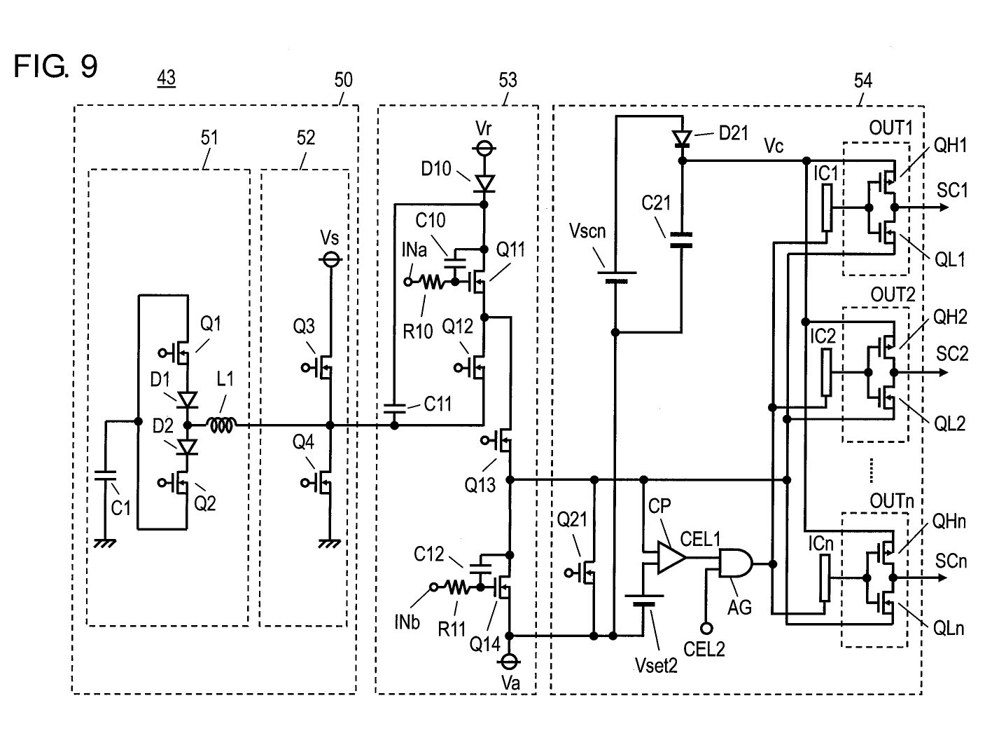

The details of scan-electrode-driving-circuit 43 and its operation are described as follows. FIG. 9 is a circuit diagram of scan-electrode-driving-circuit 43 in the first embodiment of the present invention. Scan-electrode-driving-circuit 43 includes sustain-pulse-generating-circuit 50 for generating the sustain pulse voltage, initialization-waveform-generating-circuit 53 for generating the initializing waveform voltage, and scan-pulse-generating-circuit 54 for generating the scan pulse voltage.

Sustain-pulse-generating-circuit 50 includes power-recovery-circuit 51 and clamp circuit 52. Power-recovery-circuit 51 includes capacitor C1 for power recovery, switching elements Q1 and Q2, diodes D1 and D2 for backflow prevention, and inductor L1 for resonance. Capacitor C1 for power recovery has a much larger capacity than interelectrode capacitance Cp, and is charged with Vs/2, which is about half voltage Vs so as to function as the power of power-recovery-circuit 51. Clamp circuit 52 includes switching element Q3 for clamping scan electrodes SC1 to SCn to voltage Vs, and switching element Q4 for clamping scan electrodes SC1 to SCn to 0V. Sustain-pulse-generating-circuit 50 generates sustain pulse voltage Vs based on the timing signal from timing-generating-circuit 45.

For example, when a sustain pulse is raised, switching element Q1 is turned on to make interelectrode capacitance Cp resonate with inductor L1, so that power is supplied from capacitor C1 for power recovery to scan electrodes SC1 to SCn via switching element Q1, diode D1, and inductor L1. When the voltage of scan electrodes SC1 to SCn approaches Vs, switching element Q3 is turned on to clamp scan electrodes SC1 to SCn to voltage Vs.

In the contrary, when the sustain pulse is lowered, switching element Q2 is turned on to make interelectrode capacitance Cp resonate with inductor L1, so that power is recovered from interelectrode capacitance Cp to capacitor C1 for power recovery via inductor L1, diode D2, and switching element Q2. When the voltage of scan electrodes SC1 to SCn approaches 0V, switching element Q4 is turned on to clamp scan electrodes SC1 to SCn to 0V.

Initialization-waveform-generating-circuit 53 includes two Miller integrator circuits, and two separation circuits. One of the Miller integrator circuits includes switching element Q11, capacitor C10, and resistor R10, and generates an up ramp waveform voltage gradually increasing to reach voltage Vi2. The other Miller integrator circuit includes switching element Q14, capacitor C12, and resistor R11, and generates a down ramp waveform voltage gradually decreasing to reach initialization voltage Vi4. One of the separation circuits uses switching element Q12, and the other separation circuit uses switching element Q13. Initialization-waveform-generating-circuit 53 generates the aforementioned initializing waveform voltage based on the timing signal from timing-generating-circuit 45, and controls initialization voltage Vi4 in an all-cell initializing operation. In FIG. 9, the input terminals of the Miller integrator circuits are shown as input terminals INa and INb.

When an up ramp waveform voltage of the initializing waveform voltage is generated, input terminal INa is applied with a predetermined voltage (for example, 15V) so as to set input terminal INa to “Hi”. As a result, a constant current flows from resistor R10 toward capacitor C10 so as to increase the source voltage of switching element Q11 in a ramp fashion, making the output voltage of scan-electrode-driving-circuit 43 begin to increase in a ramp fashion.

When a down ramp waveform voltage of the initializing waveform voltage is generated in the all-cell initializing operation and in the selective initializing operation, input terminal INb is applied with a predetermined voltage (for example, 15V) so as to set input terminal INb to “Hi”. As a result, a constant current flows from resistor R11 toward capacitor C12 so as to decrease the drain voltage of switching element Q14 in a ramp fashion, making the output voltage of scan-electrode-driving-circuit 43 begin to decrease in a ramp fashion.

Scan-pulse-generating-circuit 54 includes switch circuits OUT1 to OUTn, switching element Q21, control circuits IC1 to ICn, diode D21, and capacitor C21. Switch circuits OUT1 to OUTn output a scan pulse voltage to scan electrodes SC1 to SCn. Switching element Q21 clamps the low voltage side of switch circuits OUT1 to OUTn to voltage Va. Control circuits IC1 to ICn control switch circuits OUT1 to OUTn, respectively. Diode D21 applies voltage Vc to the high voltage side of switch circuits OUT1 to OUTn, voltage Vc being obtained by superimposing voltage Vscn on voltage Va. Switch circuits OUT1 to OUTn include switching elements QH1 to QHn, respectively, for outputting voltage Vc and switching elements QL1 to QLn, respectively, for outputting voltage Va. Scan-pulse-generating-circuit 54 generates scan pulse voltage Va to be applied sequentially to scan electrodes SC1 to SCn in the address period based on the timing signal from timing-generating-circuit 45. Scan-pulse-generating-circuit 54 outputs the voltage waveform of initialization-waveform-generating-circuit 53 in the initializing period without any change and also outputs the voltage waveform of sustain-pulse-generating-circuit 50 in the sustain period without any change.

Because they are applied with an extremely large current, switching elements Q3, Q4, Q12, and Q13 are each formed of parallel-connected FETs or parallel-connected IGBTs to reduce the impedance.

Scan-pulse-generating-circuit 54 includes AND gate AG for performing a logical AND operation, and comparator CP for comparing the size of input signals inputted to two input terminals. More specifically, comparator CP compares voltage (Va+Vset2) obtained by superimposing voltage Vset2 on voltage Va with the driving waveform voltage. Comparator CP then outputs “0” when the driving waveform voltage is higher than voltage (Va+Vset2); otherwise outputs “1”. AND gate AG receives two input signals, that is, output signal (CEL1) of comparator CP and switching signal CEL2. Switching signal CEL2 can be, for example, the timing signal from timing-generating-circuit 45. AND gate AG outputs “1” when both input signals are “1”; otherwise outputs “0”. The output of AND gate AG is inputted to control circuits IC1 to ICn. Scan-pulse-generating-circuit 54 outputs a driving waveform voltage via switching elements QL1 to QLn when the output of AND gate AG is “0”, and outputs voltage Vc obtained by superimposing voltage Vscn on voltage Va via switching elements QH1 to QHn when the output of AND gate AG is “1”.

Although not illustrated, the sustain-pulse-generating-circuit of sustain-electrode-driving-circuit 44 has the same structure as sustain-pulse-generating-circuit 50. The sustain-pulse-generating-circuit includes a power-recovery-circuit and two switching elements. The power-recovery-circuit recovers the power used to drive sustain electrodes SU1 to SUn for recycling. One of the two switching elements clamps sustain electrodes SU1 to SUn to voltage Vs and the other clamps sustain electrodes SU1 to SUn to 0V. The sustain-pulse-generating-circuit generates sustain pulse voltage Vs.

In the present embodiment, in initialization-waveform-generating-circuit 53, the Miller integrator circuits are formed of FETs which are practical and have a comparatively simple structure. However, the Miller integrator circuits may be replaced by other circuits as long as they can generate an up ramp waveform voltage and a down ramp waveform voltage.

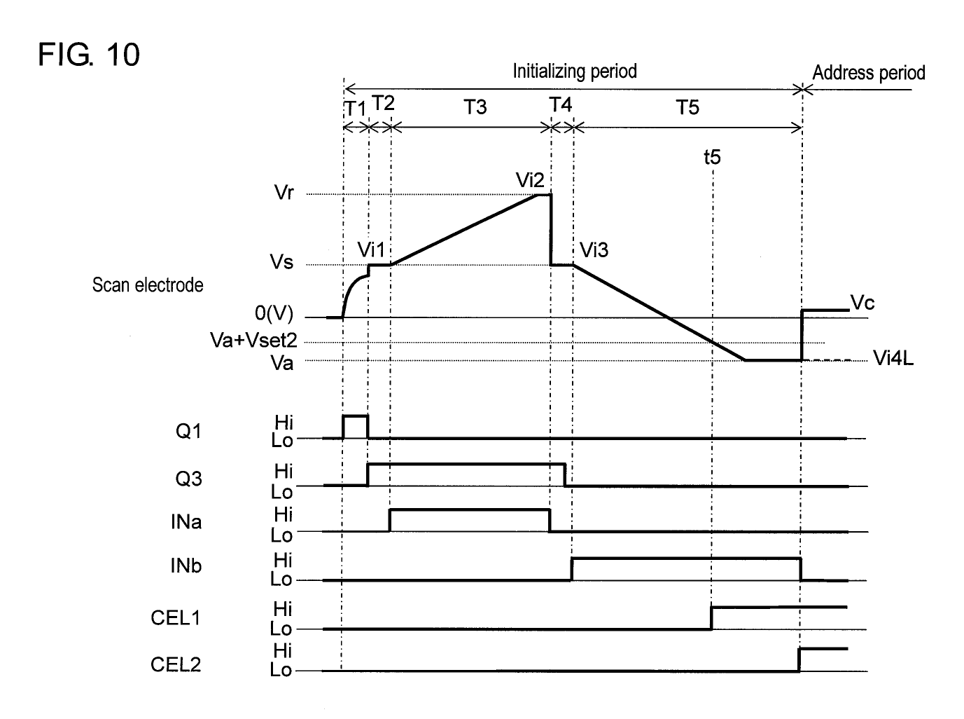

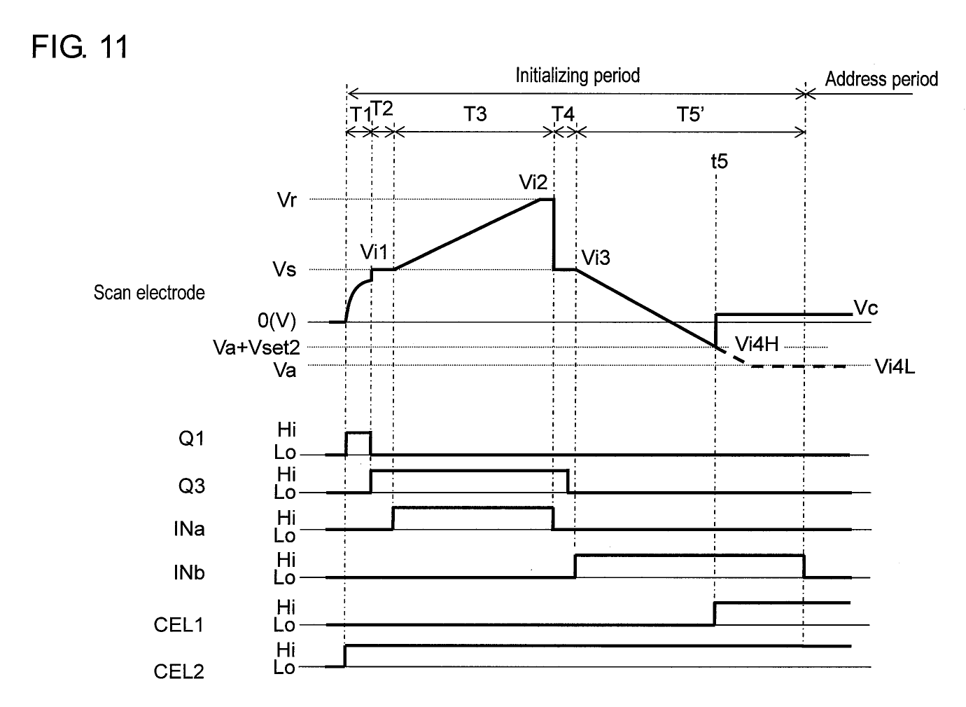

The operation of initialization-waveform-generating-circuit 53, and a method for controlling initialization voltage Vi4 are described as follows with reference to drawings. The operation of setting initialization voltage Vi4 to Vi4L is described with reference to FIG. 10 first, and then the operation of setting initialization voltage Vi4 to Vi4H is described with reference to FIG. 11. In FIGS. 10 and 11, the method for controlling initialization voltage Vi4 is described by showing the driving waveforms in an all-cell initializing operation; however, initialization voltage Vi4 can be controlled in the same manner in a selective initializing operation.

In FIGS. 10 and 11, each driving voltage waveform is divided into five periods: periods T1 to T5 in an all-cell initializing operation. These periods are described as follows. The following description is on the assumption that voltages Vi1 and Vi3, are equal to voltage Vs; voltage Vi2 is equal to voltage Vr; voltage Vi4L is equal to negative voltage Va; and voltage Vi4H is equal to voltage (Va+Vset2) which is obtained by superimposing voltage Vset2 on negative voltage Va. As a result, voltage Vi4H is higher than scan pulse voltage Va in the address period, and voltage Vi4L is equal to scan pulse voltage Va. In the following description, the operations of activating and deactivating the switching elements are referred to as “ON” and “OFF”, respectively. In the drawings, signals to switch the switching elements ON and OFF are referred to as “Hi” and “Lo”, respectively. Input signals CEL1 and CEL2 to be inputted to AND gate AG are also each referred to as “Hi” when it is “1”, and referred to “Lo” when it is “0”.

FIG. 10 is a timing chart showing an example of the operation of scan-electrode-driving-circuit 43 in an all-cell initializing period in the first embodiment of the present invention. Switching signal CEL2 is maintained at “0” in periods T1 to T5 so that initialization voltage Vi4 can be set to Vi4L. Scan-pulse-generating-circuit 54 outputs a signal to be inputted to switching elements QL1 to QLn, that is, the voltage waveform of initialization-waveform-generating-circuit 53 without any change.

### Period T1

Switching element Q1 of sustain-pulse-generating-circuit 50 is turned to the ON position. This makes interelectrode capacitance Cp resonate with inductor L1, so that the voltage to be applied from capacitor C11 for power recovery to scan electrodes SC1 to SCn via switching element Q1, diode D1, and inductor L1 starts to increase.

### Period T2

Switching element Q3 of sustain-pulse-generating-circuit 50 is turned to the ON position. This allows voltage Vs to be applied to scan electrodes SC1 to SCn via switching element Q3, so that the potential of scan electrodes SC1 to SCn becomes voltage Vs (which is equal to voltage Vi1 in the present embodiment).

### Period T3

Input terminal INa of the Miller integrator circuit generating an up ramp waveform voltage is set to “Hi”. More specifically, input terminal INa is applied with a voltage of, for example, 15V. As a result, a constant current flows from resistor R10 toward capacitor C10 so as to increase the source voltage of switching element Q11 in a ramp fashion, making the output voltage of scan-electrode-driving-circuit 43 begin to increase in a ramp fashion. This voltage increase is continued while input terminal INa is “Hi”.

When the output voltage increases to reach voltage Vr (which is equal to voltage Vi2 in the present embodiment), input terminal INa is set to “Lo”. More specifically, input terminal INa is applied with a voltage of, for example, 0V.

In this manner, scan electrodes SC1 to SCn are applied with an up ramp waveform voltage gradually increasing from voltage Vs, which is equal to or less than the starting voltage to voltage Vr, which exceeds the starting voltage. In the present embodiment, voltage Vs is equal to voltage Vi1, and voltage Vr is equal to voltage Vi2.

### Period T4

As a result of input terminal INa having been set to “Lo”, the voltage of scan electrodes SC1 to SCn decreases to reach voltage Vs (which is equal to voltage Vi3 in the present embodiment). After this, switching element Q3 is turned to the OFF position.

### Period T5

Input terminal INb of the Miller integrator circuit generating a down ramp waveform voltage is set to “Hi”. More specifically, input terminal INb is applied with a voltage of, for example, 15V. As a result, a constant current flows from resistor R11 toward capacitor C12 so as to decrease the drain voltage of switching element Q14 in a ramp fashion, making the output voltage of scan-electrode-driving-circuit 43 begin to decrease in a ramp fashion. After the output voltage has reached predetermined negative voltage Vi4L, input terminal INb is set to “Lo”. More specifically, input terminal INb is applied with a voltage of, for example, 0V.

At this moment, comparator CP compares the down ramp waveform voltage with voltage (Va+Vset2) obtained by superimposing voltage Vset2 on voltage Va. The output signal of comparator CP is switched from “0” to “1” at time t5 when the down ramp waveform voltage becomes equal to or less than voltage (Va+Vset2). However, in periods T1 to T5, switching signal CEL2 is maintained at “0”, so that AND gate AG outputs “0”. Therefore, scan-pulse-generating-circuit 54 outputs a down ramp waveform voltage having initialization voltage Vi4 set to negative voltage Va, that is, Vi4L without any change.

Vi4L is made equal to negative voltage Va. Therefore, after the down ramp waveform voltage has reached Vi4L, the voltage is maintained for a certain period of time in FIG. 10. However, this waveform is generated under the influence of the circuit configuration of FIG. 9, and the present embodiment is not limited to this waveform or the circuit configuration of FIG. 9. For example, the down ramp waveform voltage may be switched to voltage Vc immediately after it has reached Vi4L.

As described hereinbefore, in scan-electrode-driving-circuit 43, scan electrodes SC1 to SCn are applied with an up ramp waveform voltage gradually increasing from voltage Vi1 which is equal to or less than the starting voltage to voltage Vi2 which exceeds the starting voltage. After this, scan electrodes SC1 to SCn are applied with a down ramp waveform voltage gradually decreasing from voltage Vi3 to initialization voltage Vi4L.

When the initializing period is over, in the subsequent address period, switching element Q21 is maintained in the ON position, and therefore, output signal CEL1 of comparator CP is maintained at “1”. Switching signal CEL2 is set to “1” in the address period. As a result, AND gate AG receives two signals which are both “1”, and then outputs “1”. Consequently, scan-pulse-generating-circuit 54 outputs voltage Vc obtained by superimposing voltage Vscn on negative voltage Va. Although not illustrated, when switching signal CEL2 is set at “0” at the same time as the generation of a negative scan pulse voltage, the output signal of AND gate AG becomes “0”. Consequently, scan-pulse-generating-circuit 54 outputs negative voltage Va. In this manner, the negative scan pulse voltage is generated in the address period.

Next, the operation of setting initialization voltage Vi4 to Vi4H is described as follows with reference to FIG. 11. FIG. 11 is a timing chart showing another example of the operation of scan-electrode-driving-circuit 43 in an all-cell initializing period in the first embodiment of the present invention. Switching signal CEL2 is maintained at “1” in periods T1 to T5′ so that initialization voltage Vi4 can be set to Vi4H. Since the operation in periods T1 to T4 of FIG. 11 is equal to that in periods T1 to T4 of FIG. 10, the following description is focused on the operation in period T5′, which is different from period T5 of FIG. 10.

### Period T5′

In period T5′, input terminal INb of the Miller integrator circuit generating a down ramp waveform voltage is set to “Hi”. More specifically, input terminal INb is applied with a voltage of, for example, 15V. As a result, a constant current flows from resistor R11 toward capacitor C12 so as to decrease the drain voltage of switching element Q14 in a ramp fashion, making the output voltage of scan-electrode-driving-circuit 43 begin to decrease in a ramp fashion.

At this moment, comparator CP compares the down ramp waveform voltage with voltage (Va+Vset2) obtained by superimposing voltage Vset2 on voltage Va. The output signal of comparator CP is switched from “0” to “1” at time t5 when the down ramp waveform voltage becomes equal to or less than voltage (Va+Vset2). At this moment, switching signal CEL2 is at “1”, so that AND gate AG receives inputs which are both “1”, and then outputs “1”. Consequently, scan-pulse-generating-circuit 54 outputs voltage Vc obtained by superimposing voltage Vscn on negative voltage Va. Thus, the minimum voltage of the down ramp waveform voltage can be (Va+Vset2), that is, Vi4H. Input terminal INb is set at “Lo” between when the output of scan-pulse-generating-circuit 54 becomes voltage Vc, and until the initializing period is over.

Since switch circuits OUT1 to OUTn are switched according to the comparison result of comparator CP, the down ramp waveform voltage is switched to voltage Vc immediately after having reached Vi4H in FIG. 11. However, the present embodiment is not limited to this waveform; after the down ramp waveform voltage has reached Vi4H, the voltage may be maintained for a certain period of time.

Thus, in the present embodiment, scan-electrode-driving-circuit 43 has the circuit configuration of FIG. 9. In the circuit configuration, the minimum voltage of the gradually decreasing down ramp waveform voltage, that is, initialization voltage Vi4, can be easily controlled just by setting voltage Vset2 to a desired voltage level.

The present embodiment describes the control of initialization voltage Vi4 in an all-cell initializing operation; however, the control can be performed in the same manner in a selective initializing operation except that an up ramp waveform voltage is not generated although a down ramp waveform voltage is generated.

Initialization voltage Vi4 may be changed by other methods. For example, voltage Vi4 may be increased or decreased by controlling the inclination of the ramp decreasing from voltage Vi3 to voltage Vi4. The method for changing initialization voltage Vi4 in the present embodiment is not limited to the aforementioned one.

In the present embodiment, Vset2 is set to 5V so as to make Vi4H higher than Vi4L by 5V; however, Vset2 is not limited to this voltage and can preferably be set to a value determined according to the characteristics of the panel, the specification of the plasma display device, or the like.

As described hereinbefore, in the present embodiment, initialization voltage Vi4 is switched between Vi4H and Vi4L, which is lower than Vi4H, and initialization voltage Vi4 is changed depending on the current accumulated time of panel 10. When the current accumulated time of panel 10 measured by accumulated-time-measurement-circuit 48 is equal to or less than a predetermined time (500 hours or less in the present embodiment), the down ramp waveform voltage is generated with initialization voltage Vi4 set to Vi4H. After the current accumulated time exceeds the predetermined time (over 500 hours in the present embodiment), the down ramp waveform voltage is generated with initialization voltage Vi4 set to Vi4L, which is lower than Vi4H. This achieves a stable address operation without increasing address pulse voltage Vd when the current accumulated time has increased.

In the present embodiment, in the initializing period of every sub-field, the down ramp waveform voltage is generated with initialization voltage Vi4 set to Vi4H as shown in FIG. 5A when the current accumulated time is equal to or less than the predetermined time. The down ramp waveform voltage is generated with initialization voltage Vi4 set to Vi4L as shown in FIG. 5B after the current accumulated time exceeds the predetermined time. However, the sub-field structure of the present invention is not limited to this.

### Second Embodiment

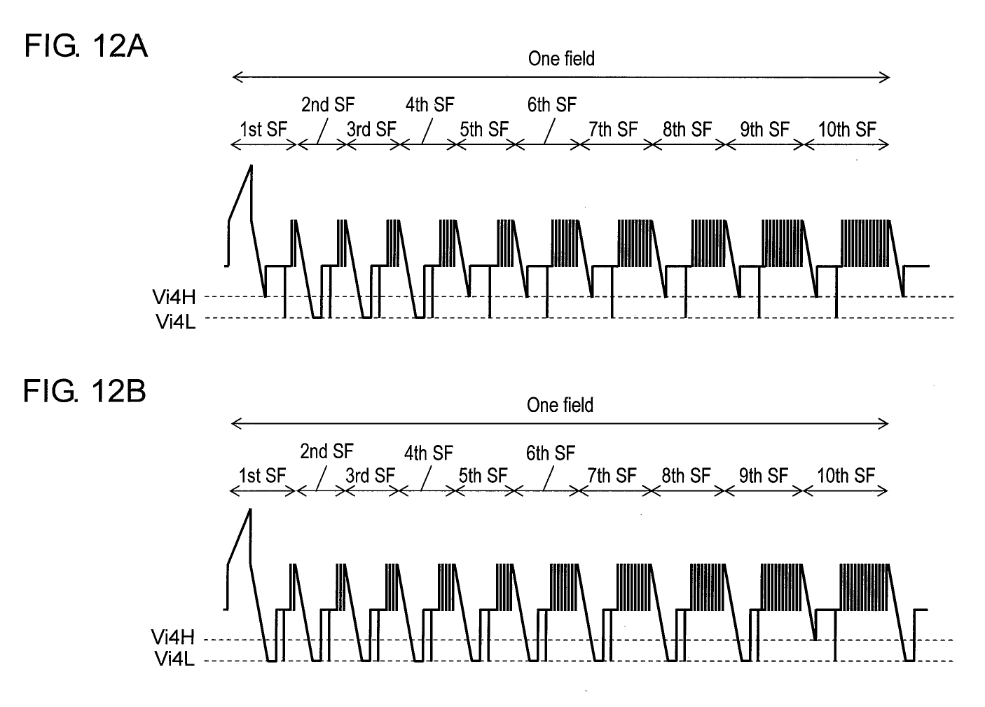

FIG. 12A shows an example of a sub-field structure according to a second embodiment of the present invention, and FIG. 12B shows another example of the sub-field structure. The second embodiment differs from the first embodiment only in the sub-field structure and is identical in the structure and operation of each circuit, each driving waveform, and the like.

The present embodiment may have a structure having a sub-field in which the down ramp waveform voltage is generated with initialization voltage Vi4 set to Vi4L when the current accumulated time is equal to or less than a predetermined time. In the example shown in FIG. 12A, the down ramp waveform voltage is generated with initialization voltage Vi4 set to Vi4H in the initializing period of each of the 1st SF and the 5th to the 10th SF, and is generated with initialization voltage Vi4 set to Vi4L in the initializing period of each of the 2nd to the 4th SF.

The present embodiment may have another structure having a sub-field in which the down ramp waveform voltage is generated with initialization voltage Vi4 set to Vi4H after the current accumulated time exceeds the predetermined time. In the example shown in FIG. 12B, the down ramp waveform voltage is generated with initialization voltage Vi4 set to Vi4L in the initializing period of each of the 1st to the 9th SF, and is generated with initialization voltage Vi4 set to Vi4H in the initializing period of the 10th SF. Thus, in the present invention, the ratio of the sub-fields in which the down ramp waveform voltage is generated with initialization voltage Vi4 set to Vi4Li in one field period should be larger after the current accumulated time exceeds the predetermined time than when the current accumulated time is equal to or less than the predetermined time. This achieves the same effect as described above.

In the first embodiment, Vset2 is set to 5V, and initialization voltage Vi4 is switched between Vi4L and Vi4H, which is higher than Vi4L by 5V. The potential of Vi4L is set to equal to negative voltage Va. However, the potential difference between Vi4L and Vi4H, and the potential of ViL are not limited to these values, but can be set to values determined according to the characteristics of the panel, the specification of the plasma display device, or the like.

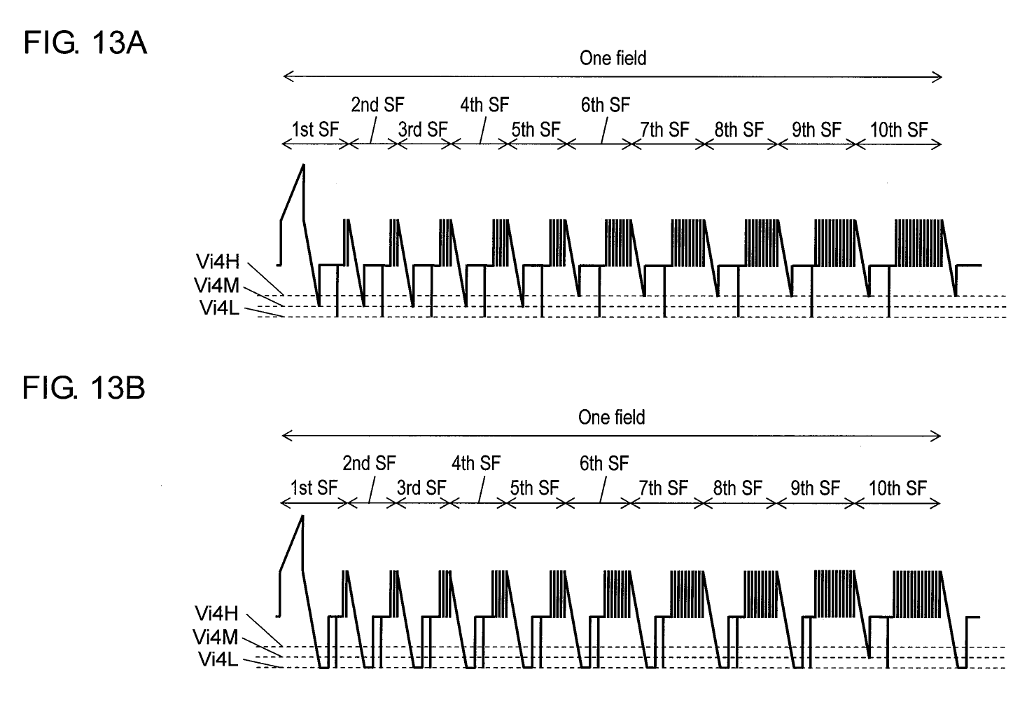

Furthermore, in the first embodiment, initialization voltage Vi4 is switched between two voltage levels: Vi4L and Vi4H, but may alternatively be switched between three or more voltage levels. FIG. 13A shows an example of a sub-field structure in the second embodiment of the present invention in which initialization voltage Vi4 has three voltage levels. FIG. 13B shows another example of the sub-field structure in the second embodiment of the present invention in which initialization voltage Vi4 has three voltage levels. It is possible to provide Vi4M between Vi4H and Vi4L. For example, Vi4H can be higher than Vi4L by 10V, and Vi4M can be higher than Vi4L by 5V. In this case, there is a sub-field in which the down ramp waveform voltage is generated with initialization voltage Vi4 set to Vi4M when the current accumulated time is equal to or less than a predetermined time. In the example shown in FIG. 13A, the down ramp waveform voltage is generated with initialization voltage Vi4 set to Vi4M in the initializing period of each of the 1st to the 5th SF, and is generated with initialization voltage Vi4 set to Vi4H in the initializing period of each of the 6th to the 10th SF. Alternatively, there may be a sub-field in which the down ramp waveform voltage is generated with initialization voltage Vi4 set to Vi4M after the current accumulated time exceeds the predetermined time. In the example shown in FIG. 13B, the down ramp waveform voltage is generated with initialization voltage Vi4 set to Vi4L equal to the scan pulse voltage in the initializing period of each of the 1st to the 9th SF, and is generated with initialization voltage Vi4 set to Vi4M in the initializing period of the 10th SF. Thus, in the present invention, the ratio of the sub-fields in which the down ramp waveform voltage is generated with initialization voltage Vi4 set to the minimum voltage (in this case, Vi4L) in one field period should be larger after the current accumulated time exceeds the predetermined time than when the current accumulated time is equal to or less than the predetermined time. This achieves the same effect as described above.

In the embodiments of the present invention, the predetermined time is set to 500 hours, and initialization voltage Vi4 is changed between when the current accumulated time is equal to or less than 500 hours and when it is over 500 hours. Alternatively, the predetermined time may be set to a value determined according to the characteristics of the panel, the specification of the plasma display device, or the like. For example, it is possible to provide a plurality of threshold values: 500 hours, 750 hours, and 1000 hours, and to gradually increase the ratio of the sub-fields in which the down ramp waveform voltage is generated with initialization voltage Vi4 set to Vi4L in one field period every time the current accumulated time exceeds a threshold value.

In the embodiments of the present invention, initialization voltage Vi4 having a down ramp waveform is changed after the current accumulated time exceeds the predetermined time. It is alternatively possible that even after the current accumulated time exceeds the predetermined time, the driving waveform is maintained until the plasma display device is in a non-operating state, and then initialization voltage Vi4 is changed when the plasma display device is again put into operation. More specifically, even if accumulated-time-measurement-circuit 48 outputs a signal indicating that the current accumulated time has exceeded the predetermined time while plasma display device 1 is in operation, that is, while timing-generating-circuit 45 is in operation and outputting the timing signals to drive panel 10, timing-generating-circuit 45 continues to output the same timing signals to drive panel 10. Then, when the plasma display device is once turned off and again turned on to start to drive panel 10, timing-generating-circuit 45 outputs a timing signal to generate a down ramp waveform voltage with initialization voltage Vi4 set to Vi4L. This structure can prevent brightness fluctuations which may be caused by changing the initializing waveform voltage while plasma display device 1 is in operation, and can also increase the image display quality.

The embodiments of the present invention do not limit the voltage values of Vi4L and Vi4H, the sub-fields in which to switch initialization voltage Vi4, the sub-field structure, and the like to the values described above. They are preferably set to values determined according to the characteristics of the panel, the specification of the plasma display device, or the like.

In the embodiment of the present invention, the discharge gas has a xenon partial pressure of 10%. When the xenon partial pressure is other than 10%, the driving voltage is determined in the same manner according to the panel.

The other specific values used in the embodiments of the present invention are just examples, and are preferably set to values determined according to the characteristics of the panel, the specification of the plasma display device, or the like.

### INDUSTRIAL APPLICABILITY

In the present invention, the minimum voltage of a decreasing ramp waveform voltage generated in the initializing period is changed depending on the accumulated time during which the panel is supplied with current. This makes it possible for a panel having high luminance to generate a stable address discharge without increasing the voltage required to generate an address discharge when the current accumulated time of the panel has increased. As the result, the present invention is useful as a plasma display device having high image display quality, and as a method for driving the panel.

1. A plasma display device comprising:
a plasma display panel including a plurality of discharge cells having display electrode pairs each consisting of a scan electrode and a sustain electrode;
an accumulated-time-measurement-circuit for measuring an accumulated time during which the plasma display panel is applied with current,
wherein one field period includes a plurality of sub-fields each having an initializing period during which the scan electrode is applied with a gradually decreasing ramp waveform voltage, an address period during which the scan electrode is applied with a negative scan pulse voltage, and a sustain period; and
a scan-electrode-driving-circuit generating the ramp waveform voltage in the initializing period to initialize the discharge cells, and generating the scan pulse voltage in the address period to drive the scan electrodes,
wherein the scan-electrode-driving-circuit changes a minimum voltage of the ramp waveform voltage depending on the accumulated time measured by the accumulated-time-measurement-circuit.

2. The plasma display device of claim 1, wherein
in every sub-field the scan-electrode-driving-circuit generates the ramp waveform voltage in such a manner that the minimum voltage of the ramp waveform voltage in the initializing period is set to a lowest voltage level in the initializing period of every sub-field depending on the accumulated time.

3. The plasma display device of claim 1, wherein
in a case where the scan-electrode-driving-circuit changes the minimum voltage of the ramp waveform voltage depending on the accumulated time, a same driving waveform is maintained until the plasma display device is in a non operating state, and then
when the plasma display device is again put into operation, the minimum voltage of the ramp waveform voltage is changed.

4. The plasma display device of claim 1, wherein
the scan-electrode-driving-circuit generates the ramp waveform voltage by switching the minimum voltage of the ramp waveform voltage between at least two voltage levels, and also by making a lowest voltage level of the at least two voltage levels equal to the scan pulse voltage.

5. A method for driving a plasma display panel, the plasma display panel, which includes a plurality of discharge cells having display electrode pairs each consisting of a scan electrode and a sustain electrode, being driven,
wherein one field period includes a plurality of sub-fields each having an initializing period during which the scan electrode is applied with a gradually decreasing ramp waveform voltage, an address period during which the scan electrode is applied with a negative scan pulse voltage, and a sustain period, the method comprising:
measuring an accumulated time during which the plasma display panel is applied with current; and
changing a minimum voltage of the ramp waveform voltage depending on the accumulated time thus measured.

6. The method for driving a plasma display panel of claim 5, wherein
the ramp waveform voltage is generated in such a manner that the minimum voltage of the ramp waveform voltage in the initializing period of every sub-field is set to a lowest voltage level depending on the accumulated time.
